(19) United States
(12) Patent Application Publication
(10) Pub. No.: US 2006/0231146 A1
(43) Pub. Date: Oct. 19, 2006

(54) Bypass valve

(76) Inventor: Raymond Lillback, Streetsboro, OH (US)

Correspondence Address: John R Hlavka;Watts Hoffmann Company, PO Box 99839, Cleveland, OH, 44199-0839, US

(21) Appl. No.: 10/533,097

(22) PCT Filed: Oct. 29, 2003
(86) PCT No.: PCT/US03/34379

§ 371 Date: Apr. 25, 2006

Related U.S. Application Data
(60) Provisional application No. 60/422,382, filed on Oct. 30, 2002.

(51) Int. Cl. F16K 11/085

(52) U.S. Cl. 137/625.47

(57) ABSTRACT

A control valve usable as a bypass/diverter valve for controlling the flow of fluid from a source to a fluid treatment device or other water handling appliance, such as a water softener. The valve has a housing that includes first and second inlet/outlet fittings and first and second fluid transfer fittings and defines a valve chamber in fluid communication with the fittings. A valve member having a valuing portion is rotatably received within the valve chamber. The valuing portion includes a circular base and a disc member spaced above the circular base with a diametral wall extending therebetween which, together define a first fluid flow path through the valve when the valuing portion is in predetermined positions within the valve chamber. The valve chamber includes a wall opening that communicates with a region of the valve chamber above the disc member. The disc member includes an apertured portion for communicating the region of the valve chamber above the disc member with a valuing member region defined between the disc member and a base, such that a second flow path is established by the valuing member region, the disc member apertures, the valve chamber region above the disc member and the wall opening in the valve chamber. The second flow path is isolated from the first flow path. A movement control member in cooperation with a moveable stop pin establishes four different ranges of motion for the valuing member in order to establish four different flow configurations for the control valve.

### TECHNICAL FIELD

The present invention relates generally to fluid control valves and in particular to a by-pass or diverter valve.

### BACKGROUND ART

By-pass valves also termed diverter valves are often used in plumbing systems to control the communication of fluid to a plumbing fixture or fluid processing device. For example, in the case of a water softener, it has been known to use a valving assembly to control the communication of source water to the water softener as well as provide a diversion path for the incoming water so that the water supply to the household is not interrupted during service of the water softener.

Known prior devices have been complex and/or expensive. Some have included multiple valves, manifolds and complex conduits in order to achieve the desired control.

Another problem associated with the installation of a plumbing fixture or fluid treatment device that includes an inlet and an outlet, such as a water softener or hot water tank, is a mismatch that often occurs between the inlet and outlet of the device and the source and the water supply pipes forming part of the plumbing system. In instances where household plumbing connections do not match the plumbing fixture connections, installers are required to devise awkward, cross-over connections in order to couple the household plumbing to the fixture. In instances where the fixture is being installed in a limited space, the installation can be extremely difficult and expensive.

U.S. Pat. No. 4,972,877 illustrates an existing bypass valve that has had commercial success. There has arisen a need for an improved bypass valve that has additional flexibility and a greater flow capacity.

### DISCLOSURE OF THE INVENTION

The present invention provides a new and improved by-pass or diverter valve that not only controls the communication of fluid to a plumbing fixture or other fluid treatment device but also provides conduit structure for providing connections to the fluid or plumbing system that are more easily adaptable to the position and location of the source and supply conduits of the system.

The present invention will be described in connection with a water treatment system and in particular, a water softener system which is normally serially connected in a fluid stream so that under normal operating conditions source water to be treated enters an inlet to the water softener and is discharged through an outlet of the water softener for delivery to a water supply. It should be understood that the present invention is adaptable to fluid systems in general in which a fluid treatment device or other appliance must occasionally be isolated from an inlet fluid stream.

In the preferred and illustrated embodiment, the valve includes a housing with four ports and a valve spool having a valving member portion for selectively communicating the ports in predetermined configurations. The housing defines a fluid chamber into which all of the ports communicate. The valving member is moveable within the chamber, to several predetermined positions and defines a flow passage segment that establishes a first flow path. When the valving member is moved to predetermined positions, the passage segment cross communicates certain of the four ports in predetermined configurations depending on the selected position. A control disc and stop member constructed in accordance with a preferred embodiment of the invention, determine the range of movement and the extreme rotative positions for the spool. The control disc is positionable in one of two positions and the stop member can also be positioned in one of two positions. With the disclosed construction, the control valve can be easily adapted to any one of four different flow configurations.

In the preferred and illustrated embodiment, two of the ports function as first and second inlet/outlet ports, each of which directly or indirectly communicates with the valve chamber. The other two ports form first and second intermediate or fluid transfer ports that also communicate, directly or indirectly with the valve chamber. The valving member defines flow control structures, such that in one of its positions, within the chamber, it cross-communicates the first and second inlet/outlet ports, and in a second position it cross-communicates one of the inlet/outlet ports with one of the transfer ports and communicates the other inlet/outlet port with the other intermediate port and in a third position, the valving member blocks flow through the valve chamber.

In the preferred and illustrated embodiment, the valve chamber is cylindrical and includes a cylindrical side wall and an end wall. A removable cover member encloses the chamber. According to this embodiment, the valving member includes a circular base, an axially spaced disc member and a diametral wall extending between the disc member and the base. A portion of the disc member defines a surface spaced from, but in confronting relationship with, a base surface defined by the base, such that the base surface and the disc member confronting surface together with the diametral wall define the flow passage segment. The disc member also defines openings for communicating a valve chamber region outside the valving member portion with a region defined between the disc member and the base. The valve chamber includes an opening for communicating the valve chamber region with one of the transfer ports. With this configuration, the region defined between the disc member and the base, the disc member apertures, the valve chamber region outside the valving member and the valve chamber opening establish a second fluid flow path that is isolated from the first flow path.

According to a feature of the invention, one of the inlet/outlet ports communicates with the valve chamber through an intermediate chamber. This configuration facilitates molding of the valve. In the preferred and illustrated embodiment, one of the intermediate or transfer ports communicates indirectly with the valve chamber through a transfer chamber.

According to still another feature of the invention, the inlet/outlet ports and intermediate ports are all associated with and communicate through fittings forming part of the control valve. The fittings are constructed to receive or attach to fluid conduits at the installation site.

According to a feature of the preferred embodiment, the end wall of the valve chamber defines a bearing for receiving shaft structure formed on the valving member. According to this feature, the cover member rotatably supports a stem portion of the valve spool so that the valve spool is rotatably held within the valve chamber and lateral movement between the valving member portion and the valve chamber is inhibited.

With the disclosed construction, the control valve can be configured such that either inlet/outlet port can be connected to the source of fluid while the other of the inlet/outlet ports is connected to a fluid supply system, i.e., a household water distribution supply. Either of the intermediate or transfer ports can be easily configured to serve as an inlet to the fluid treatment device or other appliance, while the other intermediate ports receives fluid from the fluid treatment device or other appliance. By appropriate positioning of the movement control member and the stop member, the control valve can be configured in any one of four different fluid flow configurations and thus simplify the plumbing connections between the fluid supply and fluid treatment or other fluid handling device.

Additional features of the invention will become apparent and a full understanding obtained by reading the following detailed description made in connection with the accompanying drawings.

### BRIEF DESCRIPTION OF DRAWINGS

FIG. 1 is an exploded view of a bypass/diverter valve constructed in accordance with the preferred embodiment of the invention;

FIG. 2 is a perspective view of a valve body forming part of the bypass/diverter valve shown in FIG. 1;

FIG. 3 is a perspective view of a valve spool forming part of the bypass/diverter valve shown in FIG. 1;

FIG. 4 is a top plan view of the valve spool shown in FIG. 3;

FIG. 5 is another perspective view of the valve spool shown in FIG. 3;

FIG. 6 is a schematic representation of the bypass/diverter valve showing the flow paths established by the bypass/diverter valve for one predetermined position of the valve spool;

FIG. 6A is a fragmentary, schematic view of the bypass/diverter valve shown in FIG. 6 illustrating the positioning and orientation of a control disc and associated stop pin forming part of the invention;

FIG. 7 is another schematic representation of the flow paths established by the bypass/diverter valve with the valve spool rotated to an OFF position;

FIG. 7A is a fragmentary, schematic view of the bypass/diverter valve shown in FIG. 7 illustrating the positioning and orientation of a control disc and associated stop pin forming part of the invention;

FIG. 8 is a schematic representation showing a bypass flow path established by the bypass/diverter valve with the valve spool rotated to a BYPASS position; and,

FIG. 8A is a fragmentary, schematic view of the bypass/diverter valve shown in FIG. 8 illustrating the positioning and orientation of a control disc and associated stop pin forming part of the invention;

FIGS. 9A and 9B illustrate the overall construction of a control disc forming part of the present invention;

FIG. 10 is a top plan view of the bypass/diverter valve with portions removed in order to illustrate a recess in which the control disc shown in FIG. 9 is installed;

FIGS. 11, 12, 13, 14, 15, 16, 17, 18 and 19 are schematic representations of the bypass/diverter valve showing the flow paths established by the bypass/diverter valve for various positions of a valve spool, control disc and stop pin forming part of the present invention; and,

FIGS. 11A, 12A, 13A, 14A, 15A, 16A, 17A, 18A and 19A are fragmentary, schematic views of the bypass/diverter valve shown in FIGS. 11, 12, 13, 14, 15, 16, 17, 18 and 19, respectively, and illustrate the positioning and orientation of a control disc and associated stop pin forming part of the invention.

### BEST MODE FOR CARRYING OUT THE INVENTION

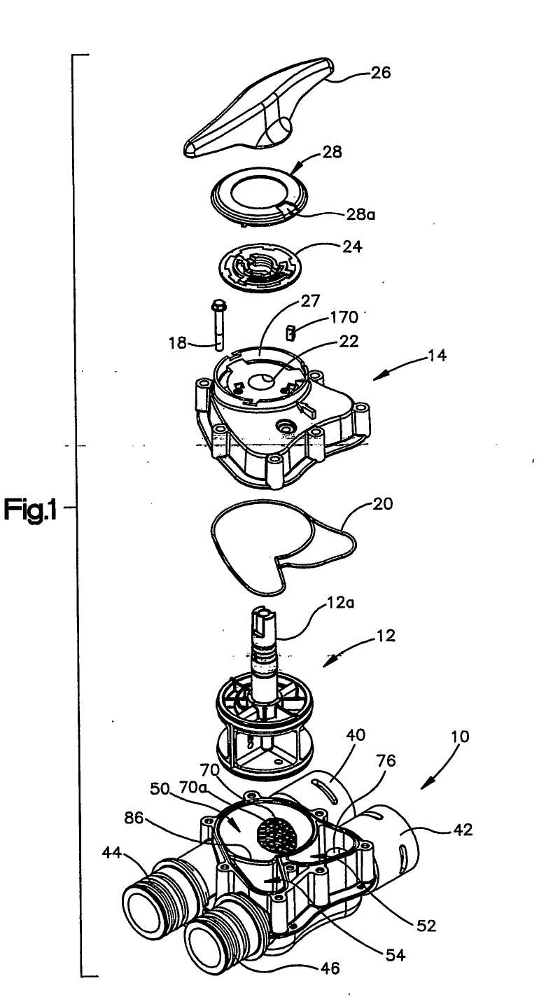

FIG. 1 illustrates an exploded view of a bypass/diverter valve constructed in accordance with the preferred embodiment of the invention. The valve includes a main valve housing indicated generally by the reference character 10, a rotatable valve spool 12 that is captured within the main housing by a cap 14 held to the housing by a plurality of bolts 18 (only one is shown). An O-ring like seal 20 seals the interface between the main housing 10 and the cap 14. An operating stem 12a of the valve spool 12 extends through an aperture 22 in the cap 14 and is engageable with a movement control disc 24 and an operating handle 26. The movement control disc sits within a recess 27 defined by the cap 14 and is maintained in position by a control disc cover 28 that includes a window 28a.

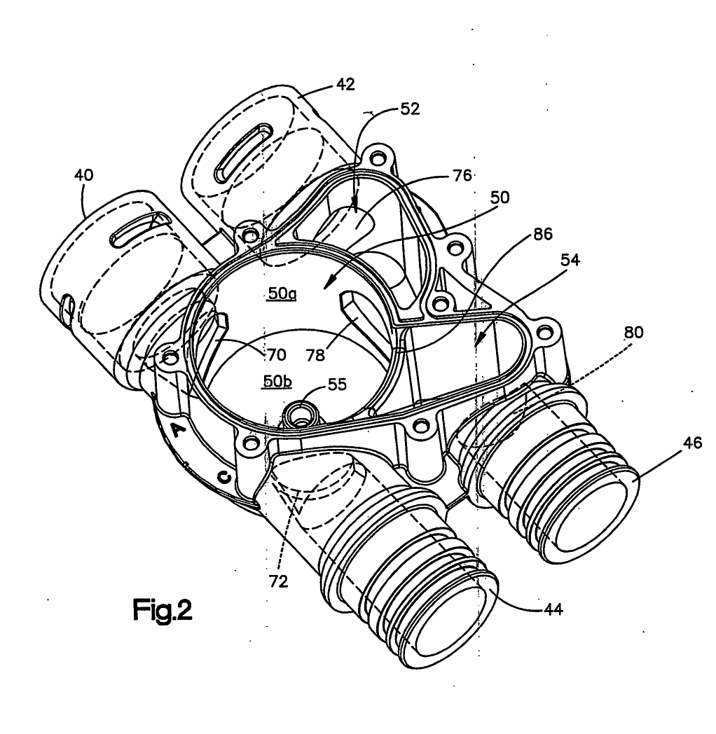

Referring also to FIG. 2, the main housing 10 includes four fittings 40, 42, 44, 46 by which fluid connections are made to the valve. In the illustrated embodiment, the fittings 40, 42 are female fittings, whereas the fittings 44, 46 are male fittings. It should be understood, however, that the fittings themselves may take various forms and all fittings may be of the same or different types. The fittings may also be of the threaded or compression type.

The fittings 40, 42 are intended to be connected to fluid supply and fluid receiving lines of a water distribution system, such as a household water supply system.

The fittings 44, 46 are intended to be connected to a water treatment system, such as a residential water softener. For purposes of explanation, the disclosed bypass/diverter valve will be discussed in connection with a residential water softener system that is used to soften incoming water and deliver it to the household water supply. In normal use, the bypass valve delivers incoming water to the water softener. After passing through the water softener the water returns to the bypass/diverter valve and is delivered to the household water supply. When desired however, such as during water softener maintenance, the spool is rotated by the handle to position it in a “bypass” position which causes incoming water received by the bypass valve to be delivered directly to the household water supply thus isolating the water softener (or other treatment device) from the incoming untreated water and the household water supply system.

The disclosed bypass/diverter valve bears some resemblance to the bypass valve disclosed in U.S. Pat. No. 4,972,877 which is hereby incorporated by reference. The disclosed valve however includes substantial enhancements and, as a result, has much more flexibility. In particular, unlike the bypass valve of the above referenced patent, the disclosed bypass valve can be configured so that the fitting 40 is connected to the incoming water conduit and the fitting 42 is connected to the household water supply or vice versa. Similarly, the fittings 44, 46 can serve as the inlet and outlet, respectively to the water treatment device or vice versa.

In the preferred illustrated embodiment, the fittings 40, 42, 44, 46 are integrally molded with the valve housing 10. The valve housing 10 defines a spool chamber 50 within which the valve spool 12 is rotatably supported. The valve housing 10 also defines an intermediate chamber 52 and a transfer chamber 54. The fittings 40, 42, 44, 46 communicate directly or indirectly with the spool chamber 50. The spool chamber is defined at least partially by uniform circular wall 50a and a base or end wall 50b that closes off one radial side of the circular wall 50a. The other radial side of the chamber 50 is closed off and defined by the removable cap 14.

As indicated above, the spool 12 rotatably rotates within the spool chamber 50. To facilitate rotation and to inhibit relative lateral movement between the bottom of the spool and the end wall 50b, the spool includes a stub shaft extending downwardly from the base of the spool (not shown). The stub shaft is received and rotatably supported by a bearing 55 forming part of the end wall 50b. With the stub shaft of the spool 12 engaged in the bearing 55, lateral movement of the spool 12 due to water pressure applied to portions of the spool 12 during its operation, is inhibited.

Referring to both FIGS. 1 and 2, the fitting 40 defines an internal passage that communicates with the spool chamber 50 through a port 70 which opens into the circular wall 50a. A screen or grating 70a may be installed in the port 70 to inhibit the ingress of solid contaminants into the spool chamber 50. The fitting 44 also defines an internal passage which communicates with the spool chamber through a port or hole 72 (indicated in phantom in FIG. 2) also formed in the wall. The fitting 42 which is preferably similar in configuration to the fitting 40 communicates indirectly with the spool chamber by means of the intermediate chamber 52 integrally formed in the housing. In particular, the fluid passage defined by the fitting 42 communicates with the intermediate chamber 52 through a port or a hole 76 in the intermediate chamber 52 which in turn communicates with the spool chamber 50 through a hole or port 78 formed in the circular wall 50a. It should be noted here that the intermediate chamber 52 facilitates the fluid communication of the fitting 42 with the spool chamber and the molding thereof. It is possible to eliminate the intermediate chamber 52 and have the fitting 42 communicate directly with the spool chamber.

The fitting 46 communicates indirectly with the valve spool chamber 50 by means of the transfer chamber 54. In particular, the fitting 46 defines an internal bore that communicates with the transfer chamber by means of a hole or port 80 (shown in phantom in FIG. 2). The transfer chamber 54 in turn communicates with the spool chamber 50 by way of a clearance gap 86 at least partially defined by the circular wall 50a. In the preferred embodiment, a portion of the gap 86 is also defined by structure in the cap 14.

As indicated above, the valve spool 12 is rotatably supported within the spool chamber 50. With the cap 14 installed, the spool 12 controls the fluid communication between the ports 70, 72, 78 formed in the cylindrical wall 50a and the gap 86 and thus controls the fluid communication between the fittings 40, 42, 44, 46 and hence the conduits (not shown) to which the fittings are connected to.

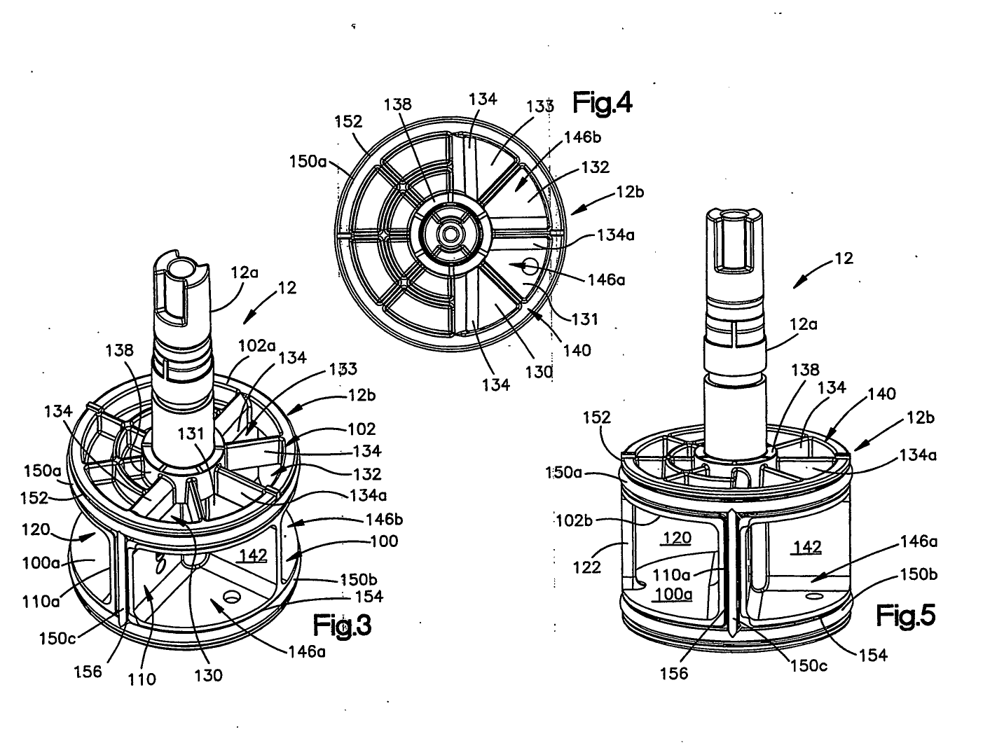

FIGS. 3-5 illustrate the construction of the spool 12. The spool includes a valving portion 12b which is generally cylindrical in shape. As indicated above, the valving portion 12b is received by and rotatable within the spool chamber 50. The valving portion 12b is defined by an annular base 100, the bottom surface of which confronts the end wall 50b of the spool chamber 50. Spaced above the base 100, a predetermined distance, is a disc-like member 102. The spacing between the base 100 and the member 102 is chosen such that when the spool 12 is installed in the spool chamber 50, an upper surface 102a of the disc member 102 lies below the lower edge of the gap 86 defined by the valve body 10.

A vertical, diametral wall 110 extends between the base 100 and disc member 102. The diametral wall 110 divides the gap defined between the base 100 and disc member 102 into isolated flow paths when the spool 12 is installed in the valve. In particular, an isolated flow passage indicated generally by the referenced character 120 is defined by a base surface 100a, a side wall surface 110a and a disc under surface 102b (see FIG. 5). When the spool 12 is installed in the chamber 50, the passage 120 defined by the surfaces 100a, 110b and 102b is operative to cross communicate the various ports defined by the valve body 10 depending on the rotative position of the spool member 12, as will be explained. A support stanchion 122 extends between the base 100 and disc member 102 and provides additional peripheral support to inhibit relative movement or bending of portions of the base 100 and disc member 102 due to fluid forces exerted on the components during use.

The portion of the spool 12 opposite to the portion that defines the passage 120 also defines a flow path, isolated from the passage 120 when the spool 12 is installed in the valve body. As seen best in FIGS. 3 and 5, the disc member 102 includes radial openings 130, 131, 132, 133. The openings are located between radial spokes 134 that extend from a central hub 138 and join and support a ring segment 140. Additional support for the ring segment 140 is provided by a short, vertical wall 142 which extends upwardly from the base 102 and joins the ring segment 140 at a spoke 134a. The vertical diametral wall 110 and auxiliary support wall 142 define fluid compartments or regions 146a, 146b which, depending on the rotative position of the spool 12, can be made to communicate with predetermined ports defined by the circular wall 50a. As should be apparent, water flowing into the region 146a can travel up through the radial openings 130, 131 and flow across the top surface 102a of the disc 102. Similarly, fluid entering the region 146b can flow up through the spokes 132, 133 and flow across the top surface 102a of the spool member. The fluid flowing across the top surface 102a can flow into an adjacent compartment or through the gap 86.

The valving portion 12b mounts a peripheral seal. The seal may comprise a molded unitary element or may comprise one or more individual seal portions. In the illustrated embodiment, an O-Ring like portion 150a is disposed around the periphery of the disc member 102. The portion 150a is carried in a groove 152 defined by the disc member 102. An O-Ring like portion 150b surrounds the periphery of the base 100 and is received in a groove 154 defined by the base 100. Vertical seal segments 150c (only one is shown) are carried by grooves 156 defined along the outside vertical edges of the vertical wall 110. The seal portions 150a, 150b, 150c sealingly engage the cylindrical wall surface 50b of the chamber 50 and serve to isolate the fluid passage 120 from the rest of the spool structure.

The seal portion 150a, 150b, 150c may form part of a unitary, seal that is mounted to the appropriate portions of the spool 12 during manufacture. The seal portions may also comprise separate sealing segments that are installed onto the spool using known methods. The seal portions may also be directly molded onto the spool valving portion 12b during manufacture of the spool 12 using well known “overmolding” techniques. Other arrangements for the seal 150 are also contemplated by the invention, and this invention should not be limited to any one type of seal construction.

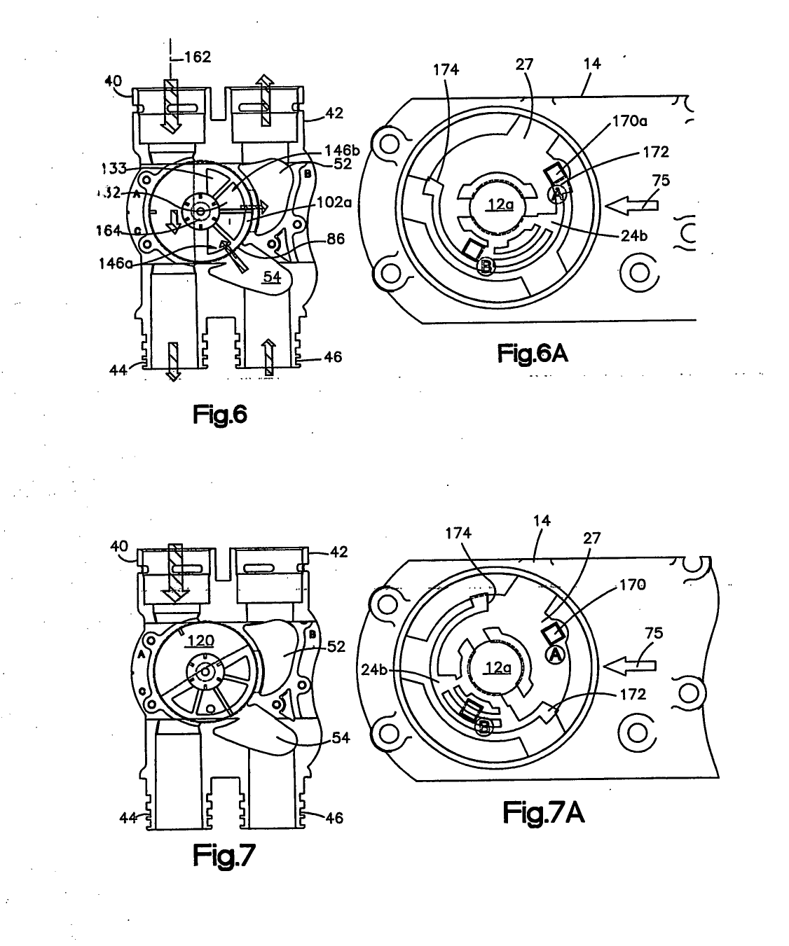

The position of the spool 12 within the spool chamber 50 determines the communication between the fittings 40, 42, 44, 46. FIG. 6 illustrates the fluid relationships between the fittings when the spool 12 is positioned as illustrated. In particular, the spool 12 is oriented such that the vertical wall 110 is parallel to an axis 162 of the fitting 40 and with the flow passage 120 defined by the valving portion 12a positioned to the left of a rotational axis 164 of the spool member 12. In this position of the spool 12, incoming water to be treated enters the fitting 40, travels through the port 70 (see FIG. 1), through the passage 120 defined by the spool 12 and into the fitting 44 by way of the port 72 (see FIG. 2). As indicated above, the bypass valve is intended to be used with a water treatment device, such as a water softener. When used for such an application, the fitting 44 would be connected to the input of the water treatment device, i.e., water softener. The treated water leaving the water treatment device is connected to the fitting 46. As seen in FIG. 6, with the spool 12 shown in the illustrated position, the treated water delivered to the fitting 46 travels through the transfer chamber 54, then through the gap 86 and onto the top surface 102a of the disc member 102. From there the treated water flows down through the radial openings, i.e., 130, 131, 132, 133 and into the regions 146a, 146b where it can then enter the intermediate chamber 52 via the port 78 (see FIG. 2). From the intermediate chamber 52, the treated water can then flow into the fitting 42 via opening or port 76 (see FIG. 2).

FIG. 7 illustrates the flow characteristics of the bypass valve when the spool member 12 is rotated approximately 60°, clockwise, from the position shown in FIG. 6. In this position, the passage 120 defined by the spool member 12 is positioned such that it does not communicate with either the intermediate chamber port 78 or the wall port 72 (that communicates with the fitting 44). It only communicates with the port 70 (see FIG. 2) associated with the fitting 40. As a result, flow is blocked to all other fittings and, in effect, the bypass valve is in an “OFF” configuration where the flow of incoming water is blocked from all other fittings. An arrow 75, molded in the cover 14 facilitates positioning of the spool. Indicia carried by the control disk 24 and visible through the window 28a of the cap 28 and aligned with the arrow 75 may be used to indicate the rotative position of the spool 12 to the user.

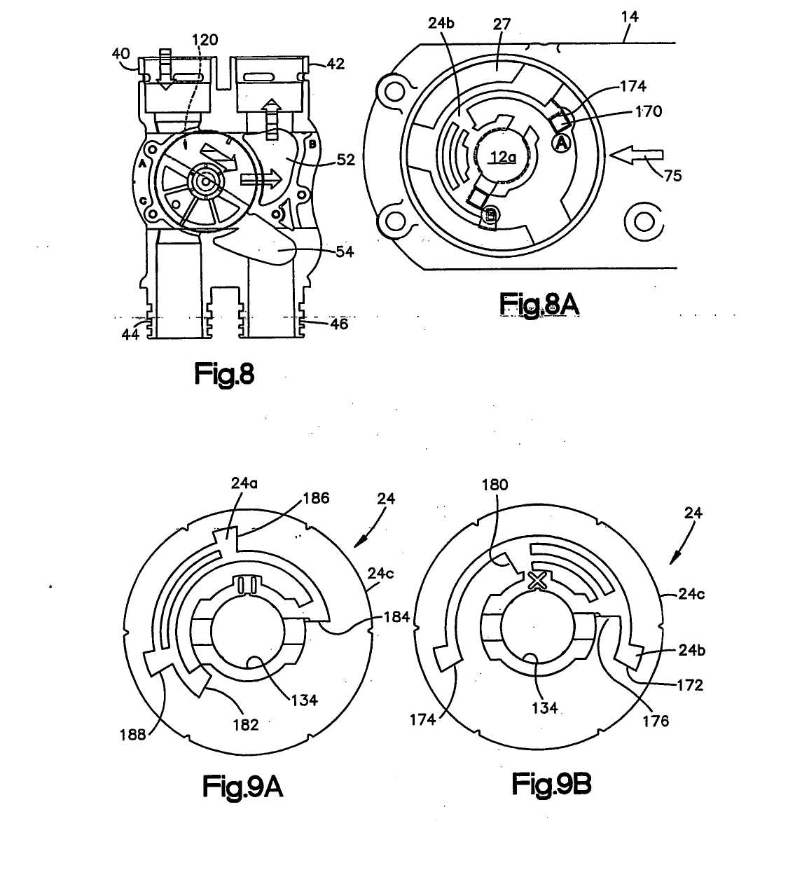

FIG. 8 illustrates a “bypass” flow position. To place the valve in a “bypass” mode, the spool 12 is rotated approximately 120° from the position shown in FIG. 6. As seen in FIG. 8, in this position the flow passage 120 defined by the valving portion 12b concurrently communicates with the port 70 and 78 defined by the circular wall segment 50b (shown in FIG. 2). As a result of this cross communication, incoming water delivered to the fitting 40 can travel through the port 70, through the fluid passage 120 and into the intermediate chamber 52 via the port 78. From the intermediate chamber 52, the water can flow directly into the fitting 42 which, as indicated above, may be connected to household water supply. In this position of the spool 12, the water treatment device, i.e., water softener, connected to the fittings 44, 46 is isolated from both the incoming water and the household water supply. With the bypass valve in the position shown in FIG. 8, the water treatment device may be serviced, disconnected, etc. without interrupting the flow of water (albeit untreated) into the household water system.

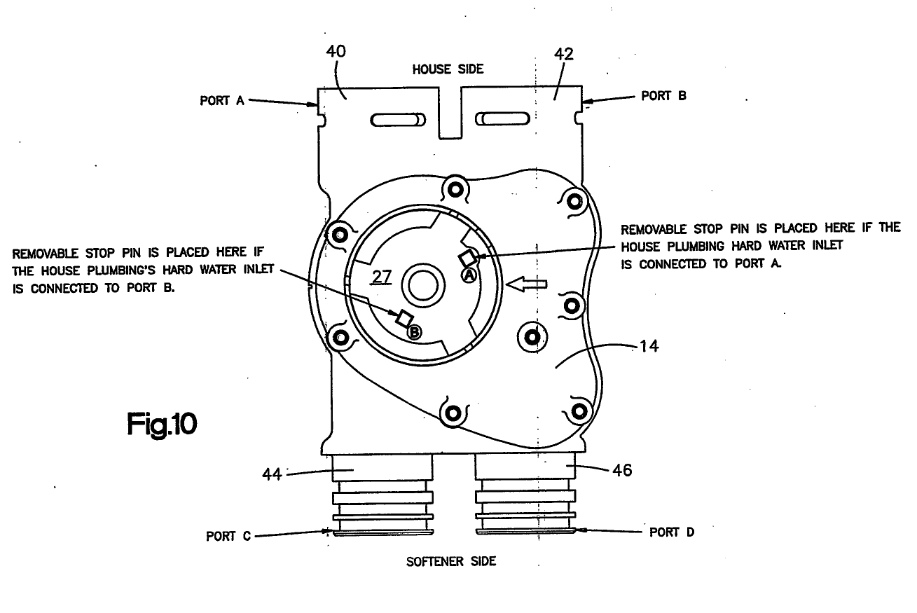

The limits of rotation for the spool 12, as shown in FIGS. 6, 7 and 8, are determined by the control disc 24 (see FIG. 1) in cooperation with a movable stop pin 130 (also shown in FIG. 1). FIGS. 9A and 9B illustrate the construction of the control disc 24. The disc 24 is preferably molded and includes wall-like structures 24a, 24b. Portions of the wall structures 24a, 24b serve as stops that are engageable with the stop pin 170 to inhibit rotation and, thus, set the limits of rotation for the spool 12. The structures 24a, 24b are located on opposite sides of a central, planar portion 24c.

The control disc 24 includes a central aperture 134 which is engageable with the stem 12a of the spool 12, as shown in FIG. 1. Referring also to FIG. 1, the initial position of the control disc 24 and whether the structure 24a or the structure 24b is located in a confronting orientation with respect to the stop pin 130 is determined by the desired flow configuration for the valve. Referring also to FIG. 10, the cover 14 includes spaced apart apertures labeled “A” and “B.” The stop pin 170 is inserted into one of these apertures, but not both. The position of the stop pin 170 in one of the apertures “A” or “B” and the position of the control disc 24, i.e. whether the side 24a or the side 24b is pointed downwardly (as viewed in FIG. 1) determines the range of motion and initial positioning of the spool 12 and, hence, the relationship between the ports 40, 42, 44, 46.

With the disc 24 being reversible so that either the wall structure 24a or the wall structure 24b can be positioned toward the bottom of the recess 27 (defined by the cover 14) in combination with the two possible positions for the stop pin 130 allow the bypass valve to be configured into four different flow configurations.

In particular, in one configuration, the fitting 40 communicates with the fitting 44 and the fitting 42 communicates with the fitting 46 when the bypass valve is in a “service” position.

In another configuration, the fitting 40 communicates with the fitting 46 and the fitting 44 communicates with the fitting 42 when the bypass valve is in a service position.

In a third configuration, the fitting 42 is connected to the source of water to be treated and communicates with the fitting 44 when the bypass valve is in the service position. When in this configuration, the fitting 46 communicates with the fitting 40 and defines a flow path through which treated water is delivered to the household supply.

In a fourth configuration, the fitting 42 is connected to a source of water to be treated and communicates with the fitting 46 when in the service position. In this configuration, the fitting 44 is connected to the output side of the water treatment device and communicates with the fitting 40, which is connected to the household water supply, when the bypass valve is in the service position. With the present invention, the disclosed bypass valve can be configured to operate with any combination of plumbing connections at the installation site. This is accomplished with a single, two-sided control disc 24, rather than requiring specialized control discs which must be changed in order to reconfigure the bypass valve.

Referring now to FIG. 6A, the relationship between the control disc 24 and, in particular, the wall structure 24b and the stop pin 170 is shown for the fluid configuration illustrated in FIG. 6. As seen in FIG. 6A, the service position is determined by the engagement between the stop pin 170 and a stop portion 172 of the structure 24b.

FIGS. 7 and 7A illustrate an OFF position for the valve configuration shown in FIG. 6. As seen in FIG. 7A, in the OFF position, no portion of the wall structure 24b engages the stop pin 132 and, in effect, is in an intermediate position, i.e., is somewhat centered with respect to the stop pin 170.

Referring to FIGS. 8 and 8A, the bypass valve is placed in a “bypass” mode by rotating the spool 12 in the clockwise direction (as viewed in FIG. 8A) until a stop portion 174 of the wall structure 24b engages the stop pin 170.

FIGS. 11-13 illustrate another fluid configuration that the bypass valve may be operated in. In this configuration, the fitting 42 is connected to the supply of untreated water, whereas the fitting 40 is connected to, and delivers treated water to, the household water supply. The fitting 46 is connected to the input side of the water treatment device (not shown) and the fitting 44 is connected to the output of the water treatment device and, hence, receives treated water. In this configuration, the control disc 24 is positioned such that the structure 24b is pointed downwardly (as viewed in FIG. 1) and is engageable with the stop pin 132. However, in this configuration, the stop pin is placed in the “B” aperture. In addition, the initial position of the spool 12 is 180° different from that shown in FIG. 7.

With the stop pin 172, the control disc 24 and spool 12 positioned as shown in FIG. 11, the bypass valve is in a “bypass” mode. In this position, the spool 12 has been rotated counterclockwise until a stop portion 176 of the wall structure 24b has engaged the stop pin 170, thus inhibiting further movement. In this position, untreated water from the fitting 42 can travel directly to the fitting 40 via the chamber 52 and the passage 120 defined by the spool valve 12.

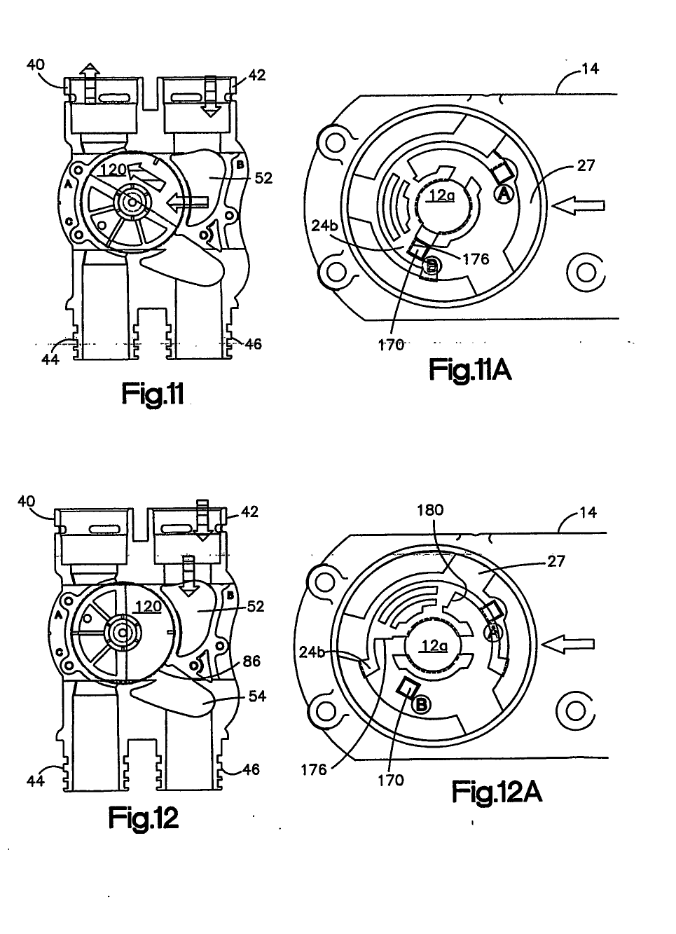

FIGS. 12 and 12A illustrate the position of the spool when the bypass valve is placed in a OFF position. As seen in these Figures, the spool 12 is rotated to an intermediate position, a position where the structure 24b does not engage the stop pin 170. Untreated water at the fitting 42 is blocked from flowing through any other portion of the valve because the passage 120 defined by the spool 12 is not in communication with any other passage in the bypass valve. (The chamber 54 can only communicate with the spool chamber 50 via the gap 86; the gap 86 does not communicate with the spool passage 120)

FIGS. 13 and 13A show the positioning of the pertinent components when the bypass valve is placed in a service position. As seen in FIG. 13A, the spool 12 is rotated in the clockwise direction until a stop portion 180 of the wall structure 24b abuts the stop pin 170, inhibiting further rotation. In this position, and as seen in FIG. 13, the spool 12 allows communication between the port 44 (which is connected to the output of the water treatment device) with the port 40 (which is connected to the household water supply) by way of the passage 120 defined by the spool 12. As also seen in FIG. 13, water to be treated is received in the port 42 and travels to the chamber 52 and then into the spool chamber by way of the port 78 (see FIG. 2). The water to be treated then flows through the openings 132, 133 in the spool 12 and then into the fitting 46 by way of the gap 86 and the chamber 54.

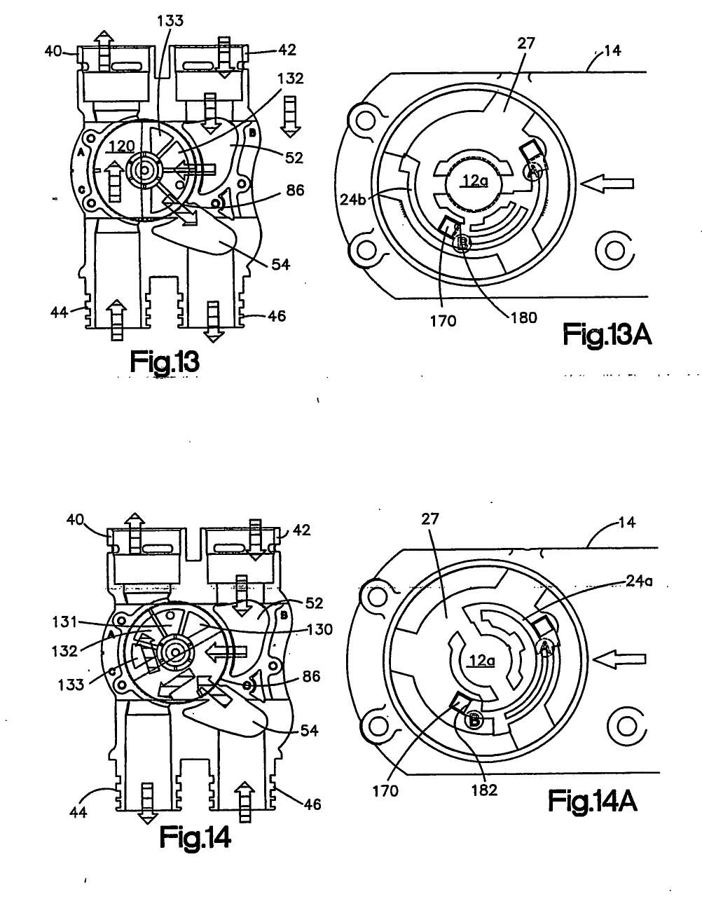

FIGS. 14-16 illustrate a third configuration for the bypass valve. In this configuration, the fitting 42 is connected to the source of untreated water and the fitting 40 is connected to the household water supply. The fitting 44 is connected to the input of the water treatment device and the fitting 46 is connected to the output of the water treatment device. In this configuration, the control disc 24 is oriented such that the wall structure 24a is positioned downwardly (as viewed in FIG. 1) and is thus engageable with the stop in 170.

FIG. 14 illustrates the “service” position of the bypass valve when in this configuration. As seen in FIG. 14A, the stop pin 170 is placed in the “B” aperture. In the service position, the spool 12 is rotated clockwise until a stop portion 182 of the wall structure 24a engages the stop pin 170 inhibiting further rotation of the spool 12. In this position, water to be treated from the fitting 42 travels into the chamber 52, through the port 78 (see FIG. 2) and into the passage 120 defined by the spool 12. The water to be treated then travels into the fitting 44 by way of the port 72 (shown in FIG. 2). Treated water is delivered to the port 46 by the water treatment device (not shown). From there the treated water travels into the chamber 54, through the gap 86 and over the top surface 102 (FIG. 3) of the spool 12. From there the treated water can flow through the openings 130, 131, 132, 133 defined by the spool 12 and then into the fitting 40 by way of the port 70 (see FIG. 2) formed in the chamber wall 50a.

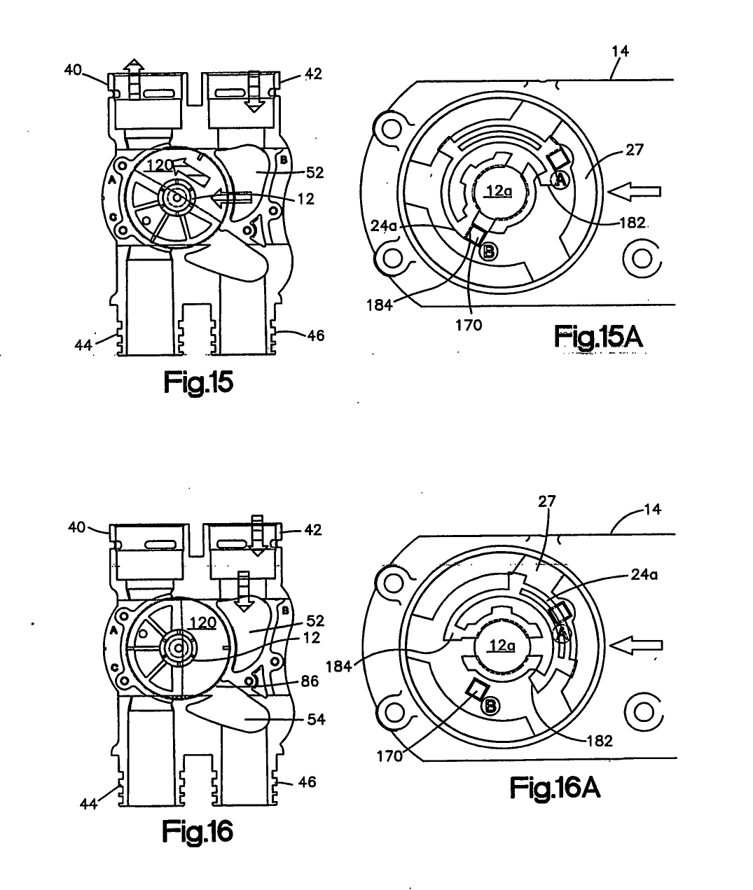

FIGS. 15 and 15A illustrate the “bypass” mode for this configuration for the bypass valve. In this mode, the spool 12 is rotated counterclockwise until a predetermined stop portion 182 of the wall structure 24a engages the stop pin 170, thus inhibiting further rotation. In this position, and as seen best in FIG. 15, untreated water is received in the fitting 42 and travels into the chamber 52 by way of the port 76 (see FIG. 2). From there the water travels through the port 78 and into the passage 120 defined by the spool valve 12. From there is travels into the fitting 40 via the port 70 (see FIG. 2).

FIGS. 16 and 16A illustrates the position of the spool 12 when the bypass valve is in the OFF position. In this mode, the spool 12 is rotated to an intermediate position, a position at which the stop pin 170 is not engaged by the stop portions 182, 184 of the wall structure 24a (an intermediate position). In this intermediate position, untreated water is conveyed to the passage 120 defined by the spool 12, but in this position, the passage does not communicate with any other portion of the valve and, hence, the flow of untreated water into the other fittings is blocked.

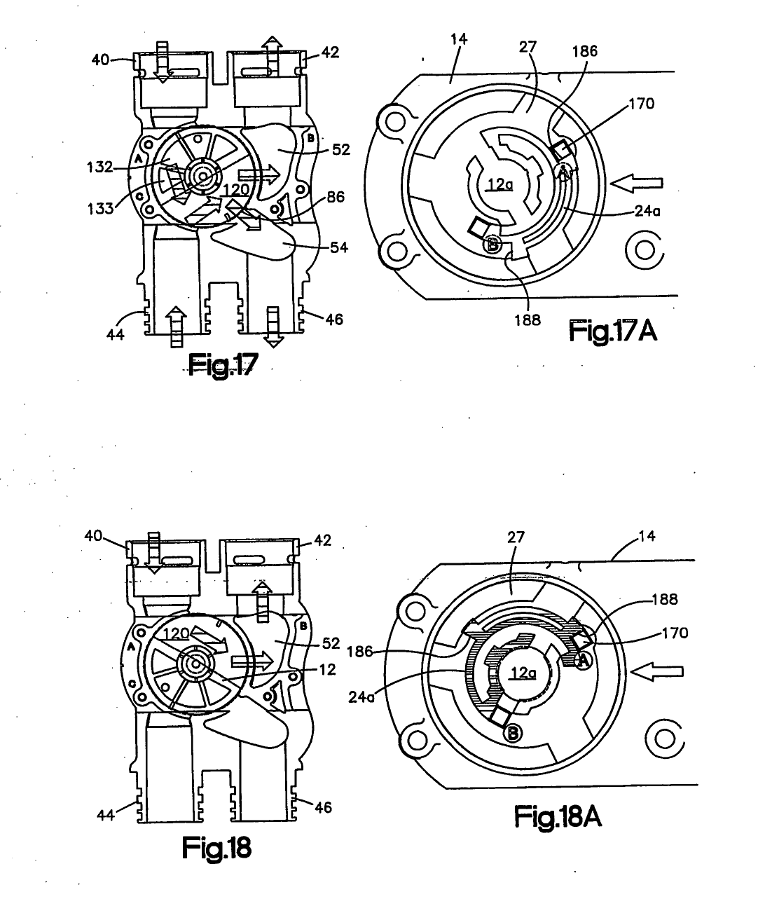

FIGS. 17-19 illustrate a fourth configuration for the bypass valve. In this configuration, the fitting 40 is connected to a source of untreated water and is communicated with the fitting 46 when the bypass valve is placed in a “service” position. In the “service” mode of this valve configuration, the fitting 46 communicates with the input to the water treatment device. The fitting 44 is connected to the output of the water treatment device (not shown) and delivers treated water to the fitting 42 which is connected to the household water supply.

In this mode of operation, the stop pin 170 is placed in the “A” aperture. When the valve is to be placed in the “service” mode, the spool 12 is rotated counterclockwise until a stop portion 186 of the wall structure 24a engages the stop pin 170 thus, inhibiting further rotation. In this position of the spool 12 (as seen in FIG. 17), untreated water received in the fitting 40 travels through the aperture 70 (see FIG. 2), through the radial openings 132, 133 in the spool valve 12 and into the auxiliary chamber 54 by way of the gap 86. From there the water travels into the fitting 46 and is thus delivered to the input of the water treatment device. Treated water received in the fitting 44 travels through the port 72 (see FIG. 2) and into the passage 120 defined by the spool 12. From there it enters the chamber 52 via the port 78 and then travels to the fitting 42 (which is connected to the household water supply).

FIGS. 18 and 18A illustrate the bypass position for the bypass valve when in this configuration. The spool 12 is rotated in the clockwise direction until a predetermined stop portion 188 of the wall structure 24a engages the stop pin 170, thus inhibiting further rotation. In this position, untreated water at the fitting 40 travels through the port 70 (FIG. 2) and into the spool passage 120. From there it travels into the chamber 52 via the port 78 (FIG. 2) and then to the fitting 42 via the port 76 FIG. 2).

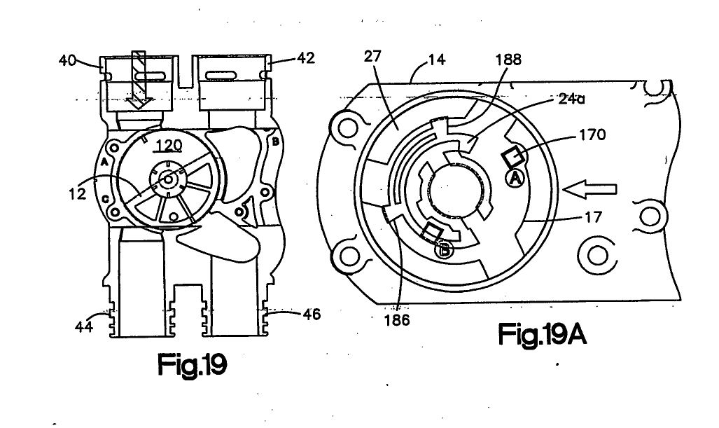

FIGS. 19 and 19A illustrate the OFF position for this configuration of the bypass valve. In this mode, the spool 12 is rotated to an intermediate position, i.e., a position where the stop pin 170 is not engaged by either stop portions 186, 188 of the wall structure 24a. As seen in FIG. 19, with the spool 12 in this position, untreated water at the fitting 40 can travel to the spool passage 120 (via the port 70, see FIG. 2), but is prevented from traveling to any other portion of the valve since the passage 120 is out of communication with all other ports or portions of the valve.

Although the invention has been described with a certain degree of particularity, it should be understood that those skilled in the art can make various changes to it without departing from the spirit or scope of the invention as hereinafter claimed.

We claim:

1. A control valve, comprising:
a) a housing defining a valve chamber;
b) a valving member disposed within said chamber and mounted for rotative movement between predetermined positions;
c) first and second inlet/outlet ports communicating with said chamber;
d) first and second intermediate ports communicating with said chamber;
e) said valving member defining flow control structure such that in one of its positions it cross communicates said first and second inlet/outlet ports, in a second position it cross communicates said one inlet/outlet port with one of said intermediate ports and communicates the other inlet/outlet port with the other intermediate port and in a third position it blocks flow through said chamber;
f) movement control member for controlling a range of rotation for said valving member; and,
g) changeable stop member cooperating with said movement control member for limiting movement in said valving member between predetermined positions.

2. The control valve of claim 1 wherein said movement control member can be installed in one of two positions, such that in one position said movement control member, in cooperation with said changeable stop member, limits movement of said valving member between said predetermined positions and in said other position, said movement control member in cooperation with said stop member limits movement of said valving member between other predetermined positions.

3. The control valve of claim 1 wherein said valving member includes a pair of spaced apart disc-like members, a portion of one of said disc-like members including apertures which allow fluid flow above and below said one disc-like member.

4. The control valve of claim 1 wherein said housing includes:
a) first and second inlet/outlet fittings communicating with said first and second inlet/outlet ports, respectively; and,
b) first and second intermediate fittings communicating and said first and second intermediate ports, respectively.

5. The control valve of claim 4 wherein said housing and said fittings are integrally molded.

6. A bypass/diverter valve for controlling the communication of a fluid supply to and from a fluid treatment device, comprising:
a) a valve housing including a pair of inlet/outlet ports, one of said inlet/outlet ports connectable to a source of fluid to be treated, the other of said inlet/outlet ports for delivering treated fluid;
b) said housing further including another pair of ports, one of said ports of said second pair for delivering fluid to be treated to a water treatment device, the other port of said second pair for receiving treated fluid from said treatment device;
c) said housing defining a cylindrical valve chamber including a cylindrical side wall and an end wall;
d) a cover member for enclosing said chamber;
e) a valve spool, at least a portion of which is mounted for rotation within said valve chamber;
f) said valve spool including a circular base, an axially spaced disc-like member and a diametral wall extending between said disc-like member and said base;
g) a portion of said disc-like member defining a surface spaced from, but in a confronting relationship with, a base surface defined by said base such that said base surface and said disc-like member confronting surface together with said diametral wall define a flow passage;
h) said disc-like member further defining openings for communicating a chamber region of said valve chamber adjacent said disc-like member with a spool region defined between said disc-like member and said base; and,
i) said cylindrical wall defining an opening in fluid communication with said chamber region, such that a flow path is established from said spool region through said openings and into one of said intermediate ports, through said wall opening, when said valve spool is in at least one predetermined position.

7. The bypass/diverter valve of claim 6 further including a movement control member coupled to said valve spool and cooperating with a moveable stop member to define the limits of rotative movement of said valve spool.

8. The bypass/diverter valve of claim 7 wherein said movement control member can be coupled to said valve spool in one of two positions and when coupled to said valve spool in the other of said two positions establishes different limits of movement for said valve spool.

9. The bypass/diverter valve of claim 6 wherein said valve spool carries a seal that sealingly engages the cylindrical side wall of said chamber.

10. The apparatus of claim 6 wherein said chamber end wall includes bearing structure for receiving and rotatably supporting a shaft structure defined by said valve spool, said engagement of said shaft structure with said bearing structure inhibiting relative lateral movement between said valve spool and said spool chamber.

11. The bypass/diverter valve of claim 7 wherein said stop member is positionable in one of two positions.

12. The bypass/diverter valve of claim 7 wherein said limits of rotative movement for said valve spool determine at least partially which of said inlet/outlet ports serves as an inlet and which of said inlet/outlet ports serves as an outlet.

13. The bypass/diverter valve of claim 12 wherein said the limits of movement for said valve spool determine, at least partially, which of said ports of said other pair deliver fluid to be treated to said treatment device and which of said ports of said other pair receive treated fluid.

14. The bypass/diverter valve of claim 8 wherein said movement control member and said moveable stop member cooperate to provide four different limits of movement for said valve spool.

15. The bypass/diverter valve of claim 6 wherein one of said ports of said other pair communicates with said wall opening through a transfer chamber.

16. The bypass/diverter valve of claim 6 wherein said valve spool includes a radial wall extending outwardly from said diametral wall and connecting said base and said disc-like member.

17. The bypass/diverter valve of claim 6 wherein one of said inlet/outlet ports communicates with said valve chamber via an intermediate chamber.

18. A control valve, comprising:
a) a housing including first and second inlet/outlet fittings and first and second fluid transfer fittings;
b) said valve housing further defining a valve chamber in fluid communication with said fittings;
c) a valve member having a stem and a valving portion, said valving portion being rotatably received within said valve chamber;
d) said valving portion including a circular base and a disc member spaced above said circular base and connected therewith by a diametral wall;
e) a portion of said disc member and a portion of said base together with said diametral wall defining a first fluid flow path through said valve chamber when said valving portion is in predetermined positions within said valve chamber;
f) said valve chamber including an opening communicating with a region of said valve chamber above said disc member; and,
g) said disc member including an apertured portion for communicating said region of said valve chamber above said disc member with a valving member region defined between said disc member and said base, such that said valving region, said disc member apertures, said valve chamber region above said disc member, and said valve chamber opening establish a second fluid flow path isolated from said first flow path.

19. The control valve of claim 18 wherein said valve chamber opening communicates with one of said fluid transfer fittings.

20. The control valve of claim 19 wherein said valve chamber opening communicates with said fluid transfer fitting via a transfer chamber.

21. The control valve of claim 20 wherein said valve chamber is cylindrical and is at least partially defined by a cylindrical wall and a circular end wall.

22. The control valve of claim 21 wherein said valve chamber is enclosed by a cover member removably attached to said valve housing.

23. The control valve of claim 22 wherein said circular end wall defines a bearing for receiving a shaft structure defined by said valve member and said cover rotatably supports said stem of said valve member.

24. The control valve of claim 21 wherein said valving portion carries at least one seal for sealingly engaging said cylindrical wall of said valve chamber.

25. The control valve of claim 24 wherein said seal is overmolded onto said valving portion of said valve member.

26. The control valve of claim 18 further including a movement control member positionable in one of two positions and a stop member positionable in one of two positions whereby four flow control configurations for said control valve are established.

27. The apparatus of claim 26 wherein said movement control member is installed in said cover and is coupled to said stem.

28. The control valve of claim 27 wherein said stop member is positionable in one of two apertures defined by said cover.
